(19) United States
(12) Patent Application Publication
(10) Pub. No.: US 2026/0153359 A1
(43) Pub. Date: Jun. 4, 2026

(54) MAGNETIC ENCODER WITH TWO TRACKS

(71) Applicant: RLS Merilna Tehnika D.O.O., Komenda (SI)

(72) Inventors: Peter Kogej, Komenda (SI); Dora Domajnko, Komenda (SI); Gregor Dolsak, Komenda (SI); David Kavrecic, Komenda (SI)

(21) Appl. No.: 18/703,941

(22) PCT Filed: Aug. 19, 2022
(86) PCT No.: PCT/SI2022/050025

§ 371 Date: Apr. 23, 2024

(30) Foreign Application Priority Data
Oct. 26, 2021 (SI) P-202100192

(51) Int. Cl. G01D 5/14; G01B 7/30

(52) U.S. Cl. CPC G01D 5/145; G01B 7/30

(57) ABSTRACT

The present invention relates to the improved magnetic encoder apparatus for measuring the position of a readhead relative to the magnetic scale. The magnetic encoder apparatus according to present invention enables the same precision of determining the position as magnetic encoders with encoded bits into the periods of the magnetic scale, disclosed in the state of the art, but improves on them by overcoming the limitation of the length of the magnetic scale imposed by the number of bits in the word. The magnetic encoder according to this invention enables multiple increase of the (measuring) length of the magnetic scale without increasing the number of the magnetic sensor elements on the readhead per track and related number of periods of the magnetic scale that the plurality of the magnetic sensor elements on the readhead extends across. Furthermore, it is possible to increase the (measuring) length of the magnetic scale without changing the length of the period on the magnetic track.

The present invention relates to the improved magnetic encoder apparatus for measuring the position of a readhead relative to the magnetic scale. The magnetic scale could be linear or curved, for example circular. Correspondingly, the position determined by the magnetic encoder apparatus can be expressed for example as a distance or as an angle from an initial point. Such apparatuses are widely used in applications, where there is need for an electronic signal that corresponds to a position or movement of an object relative to the base. The readhead is attached to the object, whereas the magnetic scale is attached to the base, or vice versa. For example, the magnetic encoder apparatuses are used for example in machine tools for determining the position of a tool, in robots for measuring angles of joints, video-surveillance systems or electric motors for determining the position of a rotor, which enables automatic operation of these devices, for example via software.

Magnetic encoders are known in the state of the art, namely U.S. Pat. No. 4,319,188 discloses the magnetic rotary encoder for detecting incremental angular displacement, angular velocity and rotating direction of a rotary member using magneto-resistors, where a magnetic medium is provided on a surface of the rotary member and is divided at a pitch p into a plurality of magnetic sections each of which has a magnetic signal recorded.

Furthermore, EP 2823260 B1 discloses the magnetic encoder apparatus with a magnetic scale that produces periodically repeating magnetic pattern, whereas in the magnetized regions of the magnetic scale data bits are encoded, which are detected by the readhead with plurality of magnetic sensor elements that extends across multiple of periods of the magnetic pattern on the magnetic scale. The plurality of magnetic sensor elements produces the plurality of sensor signals which are analyzed by an analyzer. The analyzer determines the value of data bits that are encoded in all periods in the group of magnetic periods that the magnetic sensors extend across. The determined value of the encoded data bits form a position marker that is attributed to a predefined magnetic period, for example to the most left magnetic period in the group of periods that the magnetic sensors extend across. This way, for each period on the magnetic scale there is a position marker that is attributed to that period. The data bits encoded into the magnetic scale are arranged in such a way that each magnetic period has a unique position marker attributed to it. The same document also discloses how the relative position of the plurality of magnetic sensors, or a predefined exact point within the plurality of the magnetic sensors, relative to a magnetic period is determined by calculating the phase from the plurality of sensor signals. The position of the readhead, more precisely the exact point on the readhead, relative to the magnetic scale is therefore determined by a combination of two sets of information, first, a coarse one, which period is relevant, is determined by a position marker, and second, a fine one, the relative position within that period is determined by the phase within that period. As each position marker appears only once per magnetic scale, the absolute position of the readhead can be obtained.

In the preferable embodiment of EP 2823260 B1 only one bit of information is encoded into one period of the magnetic scale. In this case the unique position marker or a codeword, which is used for encoding purposes, consists of bits. The number Nw of bits in the codeword, i.e. length of the codeword, depends on how many periods of the magnetic scale does the plurality of the magnetic sensor elements on the readhead extends across. The number Nw of bits in the codeword is essentially equal to or rounded down from the number Ne of periods of the magnetic scale that the plurality of the magnetic sensor elements on the readhead extends across. For a codeword of length Nw, the number of unique codewords, i.e. the combinations of bit values that can be generated, is equal to 2^{Nw}. Each of these unique combinations can be attributed to each period within the particular group of periods on the magnetic scale. Consequently, in order to avoid the repetition, the maximum total number Nt of periods on the magnetic scale depends on the number of bits in the word Nw, namely Nt is at most equal to or lower than 2^{Nw}.

In circular magnetic scales the last period of the magnetic scale is immediately followed by the first period of the magnetic scale, so in all positions of the readhead relative to the magnetic scale with the above mentioned encoded data bits the plurality of magnetic sensors extend across Ne periods. However, in linear magnetic scales with Nt periods, the measuring length of the magnetic scale, i.e. the length where the position of the readhead can be determined, is shortened by the length of the plurality of the magnetic sensor elements on the readhead, because when the last magnetic sensor element reaches the last period on the magnetic scale, the readhead cannot move forward. In case the readhead moved forward, the last magnetic sensor element would extend beyond the last period and thereby would not receive a corresponding magnetic signal from the magnetic scale. In order to overcome this problem, namely to achieve that the effective length of the magnetic scale is equal to the actual length of the magnetic scale with Nt periods, in some embodiments additional Ne periods can be added after the last period (Nt^{th} period) so that all magnetic sensor elements receive a corresponding magnetic signal from the periods underneath even when the last magnetic sensor element on the readhead moves beyond the Nt^{th} period. The pattern of encoded bits of the added periods is basically repeated from the first periods on the magnetic scale, so in terms of magnetic signals, we achieve analogous effect as in the circular magnetic scales when the plurality of the magnetic sensor elements extend partly across the last periods and partly across the first periods on the magnetic scale, and thereby all magnetic sensor elements in all possible positions of the readhead receive the corresponding magnetic signal from the magnetic scale.

There is a disadvantage of increasing the length of the readhead by increasing the number Nst of the magnetic sensor elements on the readhead while keeping the same distance between magnetic sensor elements in order to increase the number Ne of periods of the magnetic scale that the plurality of the magnetic sensor elements on the readhead extends across, especially when the magnetic scale is curved or circular because the magnetic sensor elements in readhead are in most cases arranged in a linear array. Consequently, the magnetic sensor elements in the middle of the readhead are closer to the magnetic scale than the magnetic sensor elements that are further away from the middle. As magnetic field strength above periodically magnetized scale decreases exponentially to the distance between the magnetic sensors and the magnetic scale, the signals that are generated by the magnetic sensor elements at the edges of the readhead might just not be sufficient for the encoded data bits to be decoded accurately by the analyzer. Therefore, it is desired to increase the measuring length of the magnetic scale without increasing the numbers Nst and/or Ne.

The magnetic encoder apparatus according to present invention enables the same precision of determining the position as magnetic encoders with encoded bits into the periods of the magnetic scale, disclosed in the state of the art, but improves on them by overcoming the limitation of the length of the magnetic scale imposed by the number Nw of bits in the word. The magnetic encoder according to this invention enables multiple increase of the (measuring) length of the magnetic scale without increasing the number Nst of the magnetic sensor elements on the readhead per track and related number Ne of periods of the magnetic scale that the plurality of the magnetic sensor elements on the readhead extends across. Furthermore, it is possible to increase the (measuring) length of the magnetic scale without changing the length of the period on the magnetic track.

The magnetic encoder apparatus according to the invention comprises
a magnetic scale comprising at least two magnetic tracks, namely a first magnetic track with a series of alternating magnetized regions of the first type and magnetized regions of the second type, periodically following one another, wherein the magnetized regions of the first type have the opposite magnetic pole to the magnetized regions of the second type, and thereby constituting number N1 of magnetic periods on the first magnetic track along its length L1,
at least one additional magnetic track with a series of alternating magnetized regions of the third type and magnetized regions of the fourth type, the magnetized regions of the third type being the opposite magnetic pole to the magnetized regions of the fourth type, and thereby constituting number N2 of magnetic periods on the additional magnetic track along its length L2,
a readhead with a plurality of first magnetic sensor elements for detecting the magnetic signal of the first magnetic track, producing a plurality of first sensor signals, and a plurality of additional magnetic sensor elements for detecting the magnetic signal of the additional magnetic track, producing a plurality of additional sensor signals.

The first magnetic sensor elements are designed in such a way so that at least one output periodic signal with N1′ signal periods, for example a sine shaped periodic signal, can be generated from the plurality of first sensor signals while the first magnetic sensor elements move above periodically magnetized regions of the first magnetic track along the length L1 of the first magnetic track. In some embodiments of the plurality of the first magnetic sensor elements, such as Hall elements, the number N1′ of signal periods of that periodic signal is essentially equal to the number N1 of the magnetic periods on the first magnetic track. In other embodiments of the plurality of the first magnetic sensor elements, such as Anisotropic Magneto-Resistive (AMR) sensors, the number N1′ of signal periods is essentially double the number N1 of the magnetic periods on the first magnetic track, because these sensors essentially generate one entire signal period per each magnetized region on the first magnetic track.

It is known in the state of the art that the plurality of magnetic sensor elements, comprising for example 4 Hall elements, produce two periodic signals depending on the position of the Hall sensor relative to the magnetic track with magnetic periods, whereas phases of these two periodic signals are shifted by a quarter of a period, for example as sine and cosine signals. Furthermore, it is also known in the state of the art, for example in WO2005008182A1, how to derive from these two periodic signals another periodic signal, namely the phase periodic signal which is directly proportional to the relative position of the Hall elements relative to the magnetic track within the period of that periodic signal, by applying the arctangent calculation on the cosine and sine signals.

Plurality of the first and the second magnetic sensor elements may be implemented in several ways, for example they may comprise Hall elements or sensors, or other types of sensors such as anisotropic magnetoresistive (AMR) sensors, giant magnetoresistive (GMR) sensors, tunnel magnetoresistive (TMR) sensors, referred to collectively as xMR sensors.

Magnetic encoders in the state of the art comprise also an analyzer, and according to the present invention the analyzer is connected to the plurality of first magnetic sensor elements and the plurality of additional magnetic sensor elements, with processing capabilities for receiving and analyzing the plurality of first sensor signals and the plurality of additional sensor signals in order to provide a position of the readhead relative to the first magnetic track and/or the additional magnetic track for example based on the relative position of the readhead within signal periods on the first magnetic track, encoded bit values on the additional magnetic track and the difference in phase between a periodic (phase) signal from the first magnetic track and a periodic (phase) signal from the additional magnetic track.

The number N2 of the magnetic periods on the additional magnetic track is increased or decreased by one period, or less than one period, relative to the number N1′ of signal periods generated by the plurality of the first magnetic sensor elements. Preferably, the number N2 of magnetic periods on the additional magnetic track is increased or decreased by exactly one relative to the number N1′ of signal periods based on the first magnetic track.

The length L2 of the additional magnetic track corresponds to the length L1 of the first magnetic track.

The first and the additional magnetic track are fixedly attached to the magnetic scale.

The length Lp1 of the magnetic period on the first magnetic track in the longitudinal direction of the first magnetic track is therefore L1/N1, and the length Lp2 of the magnetic period on the additional magnetic track in the longitudinal direction of the additional magnetic track is L2/N2.

The position of the readhead, or its exact point, relative to the first magnetic track and/or the additional magnetic track provided by the analyzer may be expressed in various ways, for example as an angle, especially if the magnetic scale is curved or circular or as an absolute position.

In some embodiments the analyzer may be mounted on or integrated with the readhead.

In possible embodiments, the entire length of each magnetic track may be composed of two or more equal sections and the above description holds for each individual section of the first magnetic track and for each individual section of the additional magnetic track. Therefore, in order not to limit the present invention to an embodiment with one section per the first magnetic track and per the additional magnetic track, it could also be defined that L1 is the length of a section of the first magnetic track, L2 is the length of a section of the additional magnetic track, N1 is the number of magnetic periods per a section of the first magnetic track, and N2 is the number of magnetic periods per a section of the additional magnetic track. Hereinafter, in the present description a reference to the first magnetic track will be interchangeably and mutatis mutandis used also to mean the section of the first magnetic track, and the reference to the additional magnetic track will be interchangeably and mutatis mutandis used also to mean the section of the additional magnetic track.

The magnetic periods on the first magnetic track have essentially a constant length Lp1 throughout the entire length L1 of the first magnetic track; and preferably all magnetized regions of the first type and all magnetized regions of the second type have the same length in the longitudinal direction of the first magnetic track.

One of at least two possible predefined data values, i.e. bit values in a 2-base system, is magnetically encoded into each magnetic period of the additional magnetic track. In a preferred embodiment, a 2-base system is applied for predefined data values, so one of the two possible predefined bit values is magnetically encoded into each magnetic period of the additional magnetic track in the following way. Each magnetized region on the additional magnetic track, belonging to at least one group of the group of magnetized regions of the third type or the group of magnetized regions of the fourth type, can be magnetized by one of the two possible values of the magnetic density, namely the first magnetic value or the second magnetic value, in order to encode a data bit. The data bit is taking a first bit value, for example logical “1”, if the magnetic density is of the first magnetic value, and the data bit is taking the second bit value, for example logical “0”, if the magnetic density is of the second magnetic value. Therefore, in each magnetic period of the additional magnetic track, either the first bit value or the second bit value can be encoded. The additional magnetic sensor elements are designed to detect the encoded bit value.

The magnetic periods on the additional magnetic track, constituted by the magnetized regions of the third type and the magnetized regions of the fourth type, have essentially a constant length Lp2 throughout the entire length L2 of the additional magnetic track regardless of the possible differences in amplitudes of the magnetic density produced by the mentioned magnetized regions. Preferably, each magnetized region of the third type in each magnetic period is modulated in terms of magnetic density, namely encoded with one of the two possible values of the magnetic density, and in such case preferably the length Lp2 of the periods is defined by the distance between two centers of two adjacent magnetized regions of the third type. Analogously, in case each magnetized region of the fourth type in each period is modulated in terms of magnetic density, the length Lp2 of the periods is defined by the distance between two centers of two adjacent magnetized regions of the fourth type.

The modulation of the magnetized region of the third type and/or the magnetized region of the fourth type on the additional magnetic track in terms of magnetic density in order to encode a predefined data value, i.e. a data bit in the 2-base system, into each period of the additional magnetic track can be achieved in several ways. In a preferred embodiment the two magnetic values of, for example the magnetized regions of the third type, is achieved by two different lengths of the magnetized regions of the third type. The first—e.g. higher—magnetic value is achieved by a longer length of that particular magnetized region of the third type composed of magnetized material, and the second—e.g. lower—magnetic value is achieved by a shorter length of that particular magnetized region of the third type composed of the same magnetic material, magnetized to the same saturation value. The length of the magnetized region of the fourth type is appropriately adjusted so that the length Lp2 of the magnetic periods on the additional magnetic track is constant regardless of which magnetic value, either higher or lower, is encoded into a particular magnetic period on the additional magnetic track.

In other embodiments, the modulation with two different values of the magnetic density of a particular magnetized region of the third type and/or of the fourth type and consequently of a particular magnetic period on the additional magnetic track, can be achieved by using the same material for that region but which is either more or less magnetized, whereas the length of the particular magnetized regions can remain essentially constant in that case. In these embodiments the first—higher—magnetic value can be achieved by magnetizing the material to the saturated magnetic level, and the second—lower—magnetic value can be achieved by magnetizing the material detectably below the saturated magnetic level. In further embodiments, the modulation can be achieved by using two different types of materials for a magnetized region that needs to be modulated, both materials magnetized to the saturated magnetic level, and each having a different magnetic saturation value.

The number Np1 of first magnetic sensor elements that extend over the length Lp1 of a magnetic period of the first magnetic track is at least two, preferably four. Similarly, the number Np2 of additional magnetic sensor elements that extend over one magnetic period of the additional magnetic track is at least two, preferably four. Therefore, the total number Nst1 of the first magnetic sensor elements on the readhead equals to Np1 multiplied by the number Ne1, namely the number of magnetic periods of the first magnetic scale that the plurality of the first magnetic sensor elements on the readhead extends across. Similarly, the total number Nst2 of the additional magnetic sensor elements on the readhead equals to Np2 multiplied by the number Ne2, namely the number of magnetic periods of the additional magnetic scale that the plurality of the additional magnetic sensor elements on the readhead extends across. The numbers Nst1 and Nst2 on a particular readhead may be identical or different.

The first magnetic sensor elements extend across at least one magnetic period of the first magnetic track, usually one to two periods. The additional magnetic sensor elements extend across at least one magnetic period of the additional magnetic track, usually five to ten periods.

Magnetic sensor elements are usually implemented as one or a combination of Hall elements, or one or a group of AMR resistive elements.

The magnetic scale according to the present invention may be implemented as a linear scale, curved scale or circular scale.

As the readhead moves along the magnetic scale, the magnetic encoder apparatus according to this invention gives the precise position of the readhead relative to the magnetic scale as an output value, either in analogue or digital form. Given that the readhead usually extends over a certain length of the magnetic scale, it must be predefined that the precise position refers to an exact point on the readhead, for example the exact position of one of the magnetic sensor elements on the readhead. So hereinafter, the term ‘position of the readhead’ will be interchangeably and mutatis mutandis used also to mean ‘position of the exact point’.

At a certain position of the readhead, the first magnetic sensor elements detect the magnetic field of the first magnetic track and from the plurality of first sensor signals it is possible to generate at least one periodic signal depending on the position with N1′ signal periods while the first magnetic sensor elements move along the length L1 of the first magnetic track. Preferably, two periodic signals, phase-shifted by a quarter of a period, for example as sine and cosine signals, are generated while moving along the length L1. Applying the arctangent calculation on the cosine and sine signals another periodic signal that is proportional to the phase within each signal period is obtained from which the relative position of the readhead within the signal period is determined. However, it cannot be determined within which signal period the readhead is located.

The additional magnetic sensor elements detect the magnetic field of the additional magnetic track. The lengths Lp2 of the periods defined by the third magnetized regions and the fourth magnetized regions are constant, but the magnetic field differs depending on the encoded data value, i.e. bit value in a 2-base system, into each period. Consequently, from the plurality of the additional sensor signals produced by the additional magnetic sensor elements, it can be determined the precise position of the exact point within a magnetic period on the additional magnetic track, and the values of bits in the codeword composed of number Nw of bits encoded into that particular magnetic period and the surrounding magnetic periods. From the combination of bits in a particular codeword—position marker, attributed to a particular magnetic period on the additional magnetic track, it can be determined within which particular magnetic period the readhead is located if the number of magnetic periods on the additional magnetic track does not exceed the maximum total number Nt which equals to or is lower than 2^{Nw} and if encoded bits are arranged in a way that each codeword attributed to a corresponding magnetic period constitutes a unique position marker. If the number N2 of the magnetic periods exceeds the number Nt, the combinations of bits in a codeword will necessarily start to repeat, so each combination will not be uniquely attributable to only one magnetic period on the additional magnetic track.

Due to the fact that the number N2 of periods on the additional magnetic track is increased or decreased by one period, or less than one period, relative to the number N1′ of signal periods based on the magnetic periods of the first magnetic track, an additional method can be applied to detect the absolute position of the readhead relative to the magnetic scale. In the preferred embodiment the difference between N1′ and N2 will be exactly 1, for example N2 will be N1′-1. A periodic signal F1 is proportional to relative position of the exact point within the signal periods on the first magnetic track and is obtained from the plurality of the first sensor signals. A periodic signal F2 is proportional to relative position of the exact point within a magnetic period on the additional magnetic track and is obtained from the plurality of the additional sensor signals. Therefore, the signal F which is calculated as a difference between F1 and F2 (F=F2−F1 or vice versa), is linearly proportional to the position of the readhead on the additional magnetic track, so the signal F will have a unique value for each position of the readhead. Therefore, an absolute position of the readhead relative to the magnetic scale can be determined from the value of the signal F. The application of the described difference between two phases, inspired by Nonius or Verier scales, in the magnetic encoder devices for determining the absolute position has in itself been disclosed in prior art, for example WO2005008182A1, DE3834200A1 and U.S. Pat. No. 6,496,266B1.

The analyzer analyzing the plurality of the first sensor signals and the plurality of the additional sensor signals by applying the above mentioned methods produces a precise and absolute position of the exact point on the readhead relative to the magnetic scale and overcomes several problems of each particular method used on its own. For example, by using only the first magnetic track, a precise relative position of the exact point can be determined, but not the absolute position if more than one period is on the first magnetic track. If only the additional magnetic track is applied, the number of periods on the additional magnetic track is limited by 2^{Nw} if each period on the additional magnetic track is to be attributed with a unique combination of bits in the word. If only the value of the signal F is used to determine the position of the exact point, the result indeed shows the absolute position, but it is, in cases of larger values of N1′, for example 50 or more, not sufficiently accurate, because the signal F changes for a relatively minor value when the readhead moves along the magnetic scale per one signal period and its monotonic increasing or decreasing is negatively affected also by the lack of quality of scale magnetization and/or errors due to in situ installation of the scale and the readhead near the limits of mounting tolerances.

By using the magnetic encoder apparatus according to the present invention and combining all the above mentioned methods, the precise absolute position of the readhead relative to the magnetic scale, although it comprises the additional magnetic track with the number of periods N2 higher than 2^{Nw}, can be determined in the following way. The relative position, namely the position within each period can be determined relatively precisely from the first sensor signals, and optionally also from the additional sensor signals, namely from any of their periodic signals F1 and/or F2. The information within which period the exact point is located, can be determined from the additional sensor signals, namely from the encoded bits within a codeword attributed to each of the magnetic periods on the additional magnetic track. However, given that the number N2 of the magnetic periods on the additional magnetic track exceeds 2^{Nw}, the combinations in codewords will start to repeat, so we need additional information on the absolute position of the exact point. This additional information is provided by the signal F which is calculated from the difference of the periodic signals F1 and F2, representing the respective phases.

Since it is only necessary to determine which codeword repetition is based on the signal F, and since the number of codeword repetitions is several times less than the number of periods, the reliable operation of the encoder can also be realized with a larger number of periods, e.g. greater than 50.

The invention will be further described by way of example, with reference to the following drawings:

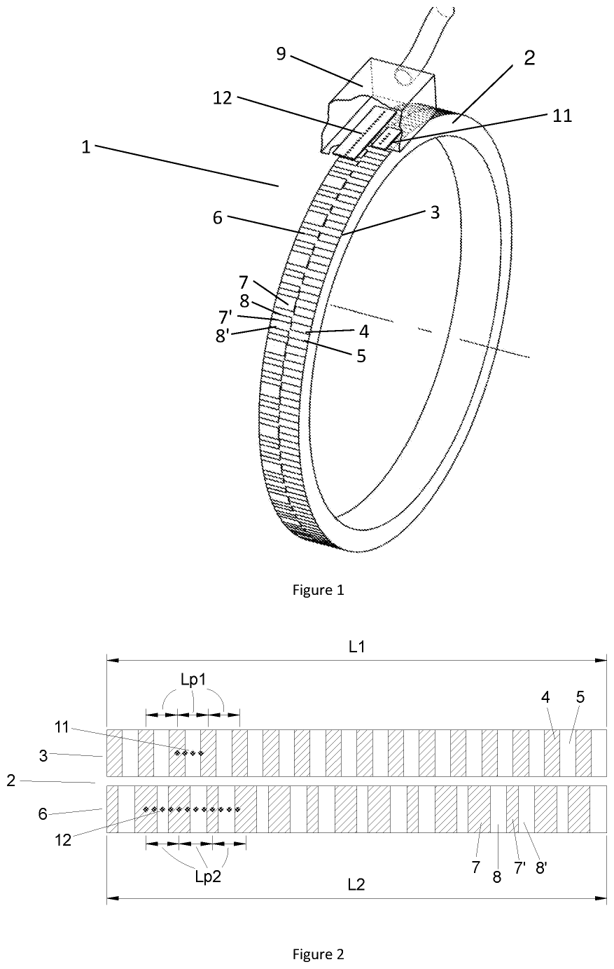

FIG. 1 shows an embodiment of a magnetic encoder apparatus according to the present invention with circular magnetic scale

FIG. 2 shows the magnetic scale of another embodiment with the first magnetic track with N1=16 magnetic periods and the additional magnetic track with N2=15 magnetic periods

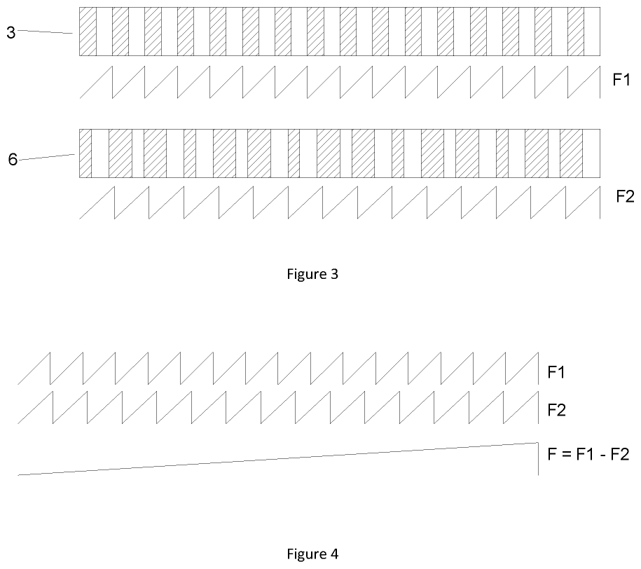

FIG. 3 shows the same magnetic scale as FIG. 2 but with accompanying periodic signal F1 for the first track and periodic signal F2 for the additional magnetic track

FIG. 4 shows both periodic signals F1 and F2 of the magnetic scale shown in FIGS. 2 and 3 and the signal F which equals to the difference between these signals, namely F=F1−F2

The embodiment of the magnetic encoder apparatus 1 shown in FIG. 1 has a circular magnetic scale 2 with the first magnetic track 3 and the additional magnetic track 6. The first magnetic track 3 comprises magnetized regions 4 of the first type and magnetized regions 5 of the second type. The additional magnetic track 6 comprises magnetized regions 7 of the third type and magnetized regions 8 of the fourth type. In this embodiment magnetized regions 7 of the third type are modulated in terms of magnetic density, namely encoded with one of the two possible values of the magnetic density, by changing the length of the magnetized regions 7 of the third type, namely higher magnetic value is achieved by a longer length of that particular magnetized region 7 of the third type composed of magnetized material, and lower magnetic value is achieved by a shorter length of that particular magnetized region 7′ of the third type composed of the same magnetic material, magnetized to the same saturation value. The magnetized region 8 of the fourth type is appropriately shorter when the magnetized region 7 of the third type is longer, so that the length Lp2 of the magnetic period is constant regardless of the encoded magnetic value encoded in a particular magnetic period. Consequently, when the magnetized region 7′ of the third type is shorter, the corresponding magnetized region 8′ of the fourth type will be longer, in order to achieve the constant length Lp2 of the magnetic periods throughout the additional magnetic track.

FIG. 1 shows also a readhead 9 with the plurality of the first magnetic sensor elements 11 and with the plurality of the additional magnetic sensor elements 12. In this embodiment the Hall elements are used for the first magnetic sensor elements and for the additional magnetic sensor elements, and the number N1′ of the signal periods on the periodic signal generated by the plurality of the first magnetic sensor elements essentially equals the number N1 of the magnetic periods on the first magnetic track. FIG. 2 through 4 pertains to another embodiment, wherein the first track 3 has N1=16 magnetic periods and the additional track 6 has N2=15 magnetic periods. The first track and the additional track as per this embodiment could be used on a linear magnetic scale or circular magnetic scale. For illustrative purposes this embodiment has relatively low numbers N1 and N2, as tracks with high numbers N1 and N2 used in practice could not be represented so clearly. In this embodiment Hall elements are used for the first magnetic sensor elements and for the additional magnetic sensor elements, and the number N1′ of the signal periods on the periodic signal generated by the plurality of the first magnetic sensor elements essentially equals the number N1 of the magnetic periods on the first magnetic track.

FIG. 2 shows the schematic representation of the magnetic scale 2 with the first magnetic track 3 and the additional magnetic track 6. The first magnetic track 3 is comprised of alternating magnetized regions 4 of the first type and the magnetized regions 5 of the second type, wherein the magnetized regions 4 of the first type have the opposite magnetic pole to the magnetized regions 5 of the second type. The length Lp1 of one magnetic period on the first track is L1/N1. The additional magnetic track 6 is comprised of alternating magnetized regions 7 of the third type and the magnetized regions 8 of the fourth type, wherein the magnetized regions 7 of the third type have the opposite magnetic pole to the magnetized regions 8 of the fourth type, and wherein the magnetized regions 7 of the third type are modulated in terms of the magnetic density, namely encoded with one of the two possible values of the magnetic density, by changing the length of the magnetized regions 7 of the third type. The higher magnetic value is achieved by a longer length of that particular magnetized region 7 of the third type composed of a magnetized material, and lower magnetic value is achieved by a shorter length of that particular magnetized region 7′ of the third type composed of the same magnetic material, magnetized to the same saturation value. The magnetized region 8 of the fourth type is appropriately shorter when the magnetized region 7 of the third type is longer, so that the length Lp2 of the magnetic period is constant regardless of the encoded magnetic value encoded in a particular magnetic period. Consequently when the magnetized region 7′ of the third type is shorter, the corresponding magnetized region 8′ of the forth type will be longer, in order to achieve the constant length Lp2 of the magnetic periods throughout the additional magnetic track. The length L2 of the additional magnetic track 6 essentially equals the length L1 of the first magnetic track 3, and the length Lp2 of the magnetic period on the additional magnetic track 6 is L2/N2.

FIG. 2 also shows schematically the plurality of the first magnetic sensor elements 11, namely the number Nst1 of the first magnetic sensor elements is four, and they extend over one (Ne1=1) magnetic period of the first magnetic track 3. The number Nst2 of the additional magnetic sensor elements 12 on the readhead is twelve, and they extend essentially over three (Ne2=3) magnetic periods of the additional magnetic track 6, so the number Nw of bits in a codeword is also three. The first magnetic period from the left on the additional magnetic track 6 has a shorter length of that particular magnetized region 7′ of the third type, so a logical “0” is attributed to that period. The next magnetic period on the additional magnetic track 6 has a longer length of that particular magnetized region 7 of the third type, so a logical “1” is attributed to that period. So all magnetic periods on the additional magnetic track have the following bits encoded therein, from left: 011011011011011. Therefore, when the plurality of the additional magnetic sensor elements will extend over the first three magnetic periods, they will detect the codeword 011; when the readhead will move for one magnetic period to the left, the additional magnetic sensor elements will detect the codeword 110, and so on.

FIG. 3 shows the same two tracks 3, 6 and below the first magnetic track 3 there is depicted the periodic signal F1 depending on the position of the readhead, generated from the plurality of the first sensor signals, and below the additional magnetic track 6 there is depicted the periodic signal F2 depending on the position of the readhead, generated from the plurality of the additional sensor signals. FIG. 4 shows periodic signal F1, periodic signal F2 and the signal F which is calculated from the difference of the periodic signals F1 and F2 (F=F1−F2), so the signal F is linearly proportional to the position of the readhead on the additional magnetic track.

When the readhead moves for one period the value of the signal F changes for a relatively small amount, namely 1/15. However, when the readhead moves for three periods and the codeword is repeated in this embodiment, the signal F changes for 1/5(=381/15) which is easily detected and calculated into the absolute position of the readhead.

Therefore, in the embodiment shown in FIGS. 2 through 4, the exact position of the readhead will be calculated in the following way: the fine relative position of the readhead will be calculated from at least one of the periodic signal generated either from the plurality of first sensor signals or the plurality of the additional sensor signals, or both; whereas a coarse position of the readhead, namely which magnetic period is relevant is calculated from the combination of a codeword generated by the bits encoded into the magnetic periods of the additional magnetic track 6 and the signal F, with which we differentiate between repeated codewords attributed to the magnetic periods of the additional magnetic track 6. With this particular arrangement of bits on the additional magnetic track 6 in this embodiment, we have three unique code words (011, 110, 101), that are repeated five times, so to differentiate between the repetitions, the difference in the signal F is applied.

1. Magnetic encoder apparatus (1) for measuring the position of a readhead (9) relative to a magnetic scale (2)
characterized in that
the magnetic scale (2) comprises at least two magnetic tracks, namely the first magnetic track (3) with alternating magnetized regions (4) of the first type and magnetized regions (5) of the second type, wherein the magnetized regions (4) of the first type being the opposite magnetic pole to the magnetized regions (5) of the second type, thereby constituting number N1 of magnetic periods on the first magnetic track (3) along its length L1, and an additional magnetic track (6) with alternating magnetized regions (7, 7′) of the third type and magnetized regions (8, 8′) of the fourth type, wherein the magnetized regions (7, 7′) of the third type being the opposite magnetic pole to the magnetized regions (8, 8′) of the fourth type, thereby constituting number N2 of magnetic periods on the additional magnetic track (6) along its length L2;
wherein the readhead (9) comprises a plurality of first magnetic sensor elements (11) for reading the magnetic signal of the first magnetic track (3), producing a plurality of first sensor signals, and a plurality of additional magnetic sensor elements (12) for reading the magnetic signal of the additional magnetic track (6), producing a plurality of additional sensor signals;
wherein the first magnetic sensor elements (11) are designed in such a way so that at least one output periodic signal with N1′ signal periods is generated from the plurality of first sensor signals while the first magnetic sensor elements (11) move above periodically magnetized regions (4, 5) of the first magnetic track (11) along the length L1 of the first magnetic track (3);
wherein the number N2 of the magnetic periods on the additional magnetic track (6) is increased or decreased by one period, or less than one period, relative to the number N1′ of signal periods generated by the plurality of the first magnetic sensor elements (11); and
wherein one of at least two possible predefined data values is magnetically encoded into each magnetic period of the additional magnetic track (6), wherein the additional magnetic sensor elements (12) are designed for detecting the magnetically encoded data value.

2. An apparatus according to claim 1, wherein a 2-base system is applied for predefined data values, so one of the two possible predefined bit values is magnetically encoded into each magnetic period of the additional magnetic track (6).

3. An apparatus according to claim 1, wherein the length L2 of the additional magnetic track (6) corresponds to the length L1 of the first magnetic track (3).

4. An apparatus according to claim 1, wherein the additional magnetic track (6) is fixedly attached to the magnetic scale (2) relative to the first magnetic track (3).

5. An apparatus according to any claim 1, wherein the number N2 of magnetic periods on the additional magnetic track (6) is increased or decreased by exactly one relative to the number N1′ of signal periods based on the first magnetic track (3).

6. An apparatus according to claim 1, wherein the plurality of the first magnetic sensor elements (11) and the plurality of the second magnetic sensor elements (12) are selected from one of the following pluralities of sensors: Hall sensors, AMR sensors, GMR sensors or TMR sensors.

7. An apparatus according to any claim 1, wherein it comprises an analyzer with processing capabilities that is connected to the plurality of first magnetic sensor elements (11) and the plurality of additional magnetic sensor elements (12), for receiving and analyzing the plurality of first sensor signals and the plurality of additional sensor signals in order to provide a position of the readhead (9) relative to the magnetic scale (2).

8. An apparatus according to any claim 1, wherein the magnetic periods on the first magnetic track (3) have essentially a constant length Lp1 throughout the entire length L1 of the first magnetic track (3); and preferably all magnetized regions (4) of the first type and all magnetized regions (5) of the second type have the same length in the longitudinal direction of the first magnetic track (3).

9. An apparatus according to claim 1, wherein each magnetized region (7, 7′) of the third type in each magnetic period on the additional magnetic track (6) is modulated in terms of magnetic density, namely encoded with one of at least two possible values of the magnetic density, wherein the length Lp2 of the magnetic periods is defined by the distance between two centers of two adjacent magnetized regions (7, 7′) of the third type, and wherein the length Lp2 is constant throughout the entire length L2 of the additional magnetic track (6).

10. An apparatus according to claim 1, wherein the magnetic scale (2) is implemented as a linear scale.

11. An apparatus according to claim 1, wherein the magnetic scale (2) is implemented as a curved scale, preferably as a circular scale.

12. An apparatus according to claim 1, wherein the additional magnetic sensor elements (12) extend across at least one magnetic period of the additional magnetic track (6), preferably across five to ten periods.

13. An apparatus according to any claim 1, wherein the number N1′ of signal periods of the periodic signal generated from the plurality of first sensor signals is essentially equal to the number N1 of the magnetic periods on the first magnetic track (3).

14. An apparatus according to claim 1, wherein the number N1′ of signal periods of the periodic signal generated from the plurality of first sensor signals is essentially double the number N1 of the magnetic periods on the first magnetic track (3).
